(19) United States
(12) Patent Application Publication
(10) Pub. No.: US 2005/0254661 A1
(43) Pub. Date: Nov. 17, 2005

(54) Wireless device for capturing multiple channel audio

(75) Inventors: Julio C. Castaneda, Coral Springs, FL (US); Brian L. Adair, Weston, FL (US); Eric S. Penrod, Sunrise, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/845,752

(22) Filed: May 14, 2004

(51) Int. Cl. H04R 5/00

(52) U.S. Cl. 381/26; 381/123; 381/311

(57) ABSTRACT

A wireless device (300) receives and captures multiple-channel audio signals and outputs the multiple-channel audio signals on at least one channel output stream (606). The wireless device (300) includes a microphone (401) for capturing a first audio channel and at least one speaker (402) for capturing additional audio channels. Each speaker has a switch (403) to enable the speaker to operate as an additional microphone for capturing at least one additional audio channel. The device also has a comparator (404), connected to a plurality of audio channels including the first audio channel and any additional audio channels, so that the comparator identifies which of the audio channels has a predetermined signal strength so as to identify one of the audio channels as a reference audio channel (406, 405). Additionally, in one embodiment, the comparator identifies which of the audio channels has a predetermined phase and identifies one of the audio channels as a reference phase channel (406, 405). The device also has an encoder (407) for receiving the plurality of audio channels to produce an output over at least one channel where the reference audio channel forms a reference signal and the audio channels other than the reference signal each form a delta signal from the reference channel.

### BACKGROUND OF THE INVENTION

1. Field of the Invention

This invention relates in general to wireless devices and more particularly, to wireless devices that capture multiple channel audio signals.

2. Description of the Related Art

The mechanical and electrical aspects of a speaker are well known by those having ordinary skill in the art. In its normal use, a speaker is a transducer which converts electrical signals to audio waves. Most speakers are constructed of an electromagnet surrounded by a natural permanent magnet. Coiled wire on the electromagnet is connected to a positive speaker wire on one end and a negative speaker wire on the other end. When an electrical current is sent through the wire, the electromagnet becomes magnetized and acts like a second natural magnet. Changing the orientation of the poles causes the electromagnet to become attracted to, or repelled by, the permanent natural magnet, causing the electromagnet to move back and forth, causing a speaker cone to move and, as a result, push air. This movement of air particles, known as a sound wave, is the sound we hear.

The human brain has the ability to automatically detect the location of a source of sound waves by measuring even very small time delay and amplitude differences between the waves when received in one ear compared to the same wave received in the other ear. Because the brain is used to determine signal sources in this manner, the recreation of sounds on a single source, such as a single speaker, or multiple speakers broadcasting the same audio signal, do not seem realistic. For instance, when a single microphone records a conversation between two people, a single audio channel is captured. The channel can record the audio signals received, but cannot detect and record the phase difference between separate audio sources, i.e., the two people. This is called “single channel” audio capture. When the single channel audio capture is played back, the recording sounds as though both people are standing in the same location without any perceivable acoustical separation between the audio sources.

Recording audio onto multiple channels has been known for quite some time. Recording on multiple channels allows for a more realistic recreation of the original audio sources to recreate the separation between the audio sources along with the attendant phase differences. A few common uses of a multi-channel recording include home stereo systems and movie theater sound systems, where multiple speakers are utilized. For instance, when watching a movie in a theater, multiple speakers are distributed throughout the room. When an actor in the center of the screen speaks, his voice emanates from the front speakers. When an actor on the left speaks, his voice emanates from speakers on the left side of the theater. The opposite takes place for an actor on the right side of the screen. This type of playback is commonly called “surround sound.”

A surround-sound recording can be created with two or more channels. Examples can be found at online URL electronics.howstuffworks.com. For example, when recording on only two channels, four streams of information can be derived. The four streams are:
a) The information in stream A
b) The information in stream B
c) The information that is the same in stream A and stream B
d) The difference between the information in stream A and stream B

In this way, a center channel can be realized even though only the right and left channels were originally recorded. The signal for the center channel is recorded on both the A stream and the B stream. The center signals recorded on both streams are identical in amplitude and frequency, and they are synchronized exactly. When the sounds are recreated, stream A can be played on a first speaker, stream B can be played on a second speaker, and the difference between the information in stream A and stream B can be played back on a center speaker to recreate the center channel. Of course, having a third input channel allows a center channel to be recorded directly and produces a three-channel output with the advantage of not having to mathematically manipulate two other signals. Thus, the more input channels available, the better the playback quality will be. Because the playback of surround sound is so realistic, the capture of multiple channels is becoming desirable in many applications.

Radio frequency communication systems, such as portable telephone systems, permit a user to communicate from locations within a broad geographic coverage area. Portable telephones generally have a compact size so that the user may more easily carry the telephone, and typically include a housing, or “handset,” containing a transceiver circuit, a user interface, a speaker at one end and a microphone at the other. The user interface includes a keypad and a display. The speaker and microphone are positioned so that the handset can be held with the speaker adjacent to the user's ear and the microphone in proximity to the user's mouth. The speaker is employed to convert electrical signals into sound waves in the human-audible frequency range of 20 Hertz (Hz) to 20,000 kilo-Hertz (kHz). When positioned against the user's ear during private operation, the speaker enables a user of the telephone to hear a representation of a caller's voice, as well as other sounds such as dial tones. The microphone is employed to do the opposite; it converts sound waves into electrical signals so they can be transmitted to the receiving device and converted back into sound waves.

Some wireless devices, such as that disclosed in U.S. Pat. No. 6,546,101B1, incorporate both cellular and dispatch (two-way) modes of operation to provide the user with the option of using either duplex communications through the cellular mode or simplex communications through the dispatch mode. The dispatch and cellular modes may be offered through the use of two separate speakers (transducers), one for each mode of operation. Other wireless devices port the audio through a single speaker by internally switching between dispatch and cellular operating modes.

Most cellular phones are also provided with an external jack, with which to attach an additional small speaker, called an earpiece. The earpiece is attached to a wire connecting the small speaker to the phone. This setup provides a distance between the speaker and the microphone in the handset.

Currently, cellular phones capture sound with a single microphone and transmit audio information as at least one channel. Other wireless devices, such as PDA's, computers, and more suffer from the same disadvantage. Thus, the capture of high quality, multi-channel audio is not currently possible from prior art wireless devices.

Accordingly, a need exists for a wireless device that captures multi-channel audio.

### SUMMARY OF THE INVENTION

The present invention concerns a wireless device for capturing multiple channel audio. The wireless device includes a microphone for capturing a first audio channel and at least one speaker for capturing additional audio channels. Each speaker has a switch to enable the speaker to operate as an additional microphone for capturing at least one additional audio channel. The device also has a comparator, connected to a plurality of audio channels including the first audio channel and any additional audio channels, so that the comparator identifies which of the audio channels has a predetermined signal strength so as to identify one of the audio channels as a reference audio channel. Additionally, the comparator identifies which of the audio channels has a predetermined phase and identifies one of the audio channels as reference phase channel. The device also has an encoder for receiving the plurality of audio channels to produce an output over at least one channel where the reference audio channel forms a reference signal and the audio channels other than the reference signal each form a delta signal from the reference channel.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention, in which:

FIG. 1 is a diagram of a speaker;

FIG. 2 is a diagram of a wireless device;

FIG. 3 is a block diagram of a wireless device, such as a telephone of FIG. 2;

FIG. 4 is a block diagram of a two-channel input/one-channel output device;

FIG. 5 is a diagram of an output stream of a two-channel input/one-channel output device;

FIG. 6 is a block diagram of an encoder device;

FIG. 7 is a flow diagram of a two-channel input/one-channel output device;

FIG. 8 is a block diagram of a three-channel input/one-channel output device;

FIG. 9 is a diagram of an output stream of a three-channel input/one-channel output device; and

FIG. 10 is a flow diagram of a three-channel input/one-channel output device.

### DETAILED DESCRIPTION OF THE PREFERRED EMBODIMENT

General:

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the specification concludes with claims defining the features of the invention that are regarded as novel, it is believed that the invention will be better understood from a consideration of the following description in conjunction with the drawing figures, in which like reference numerals are carried forward.

Exemplary Speaker

A speaker is an electoacoustic transducer mainly used for radiating acoustic energy into the air, the acoustic waveform being equivalent to the electrical input waveform. Referring first to FIG. 1, a speaker 100 is shown. Speaker 100 has a cage 101 attached to a permanent magnet 102. Magnet 102 has a donut shape and surrounds electromagnet 103, which is attached to speaker cone 104, which in turn, is supported at the upper periphery 105 of cage 101. As current fluctuates through electromagnet 103, the electromagnet 103 becomes polarized and is either repelled or attracted to permanent magnet 102. The force moves the speaker cone 104 and causes a physical disturbance pattern in the air.

When operated in a reverse mode, speaker 100 becomes a microphone and converts a physical disturbance in the air, or sound wave, to an electrical signal. When operating in the reverse mode, or receive mode, sound waves impact the speaker cone 104, causing the cone 104 to move, thereby causing the electromagnet 103 to move relative to the permanent magnet 102. The movement relative to the permanent magnet 102 causes induction in the coil of the electromagnet 103 and creates a current flow. By measuring the amount and polarity of current flow, the movement of the speaker cone 104 can be determined and captured. When operating a speaker in a reverse mode, it functions similar to a microphone to capture audio. Using this principle of operating a speaker in a reverse mode, a wireless device with one or more speakers is used to capture multi-channel high-quality audio. In some embodiments, the wireless device includes microphones, as well as speakers, to capture multi-channel audio.

Exemplary Wireless Telephone

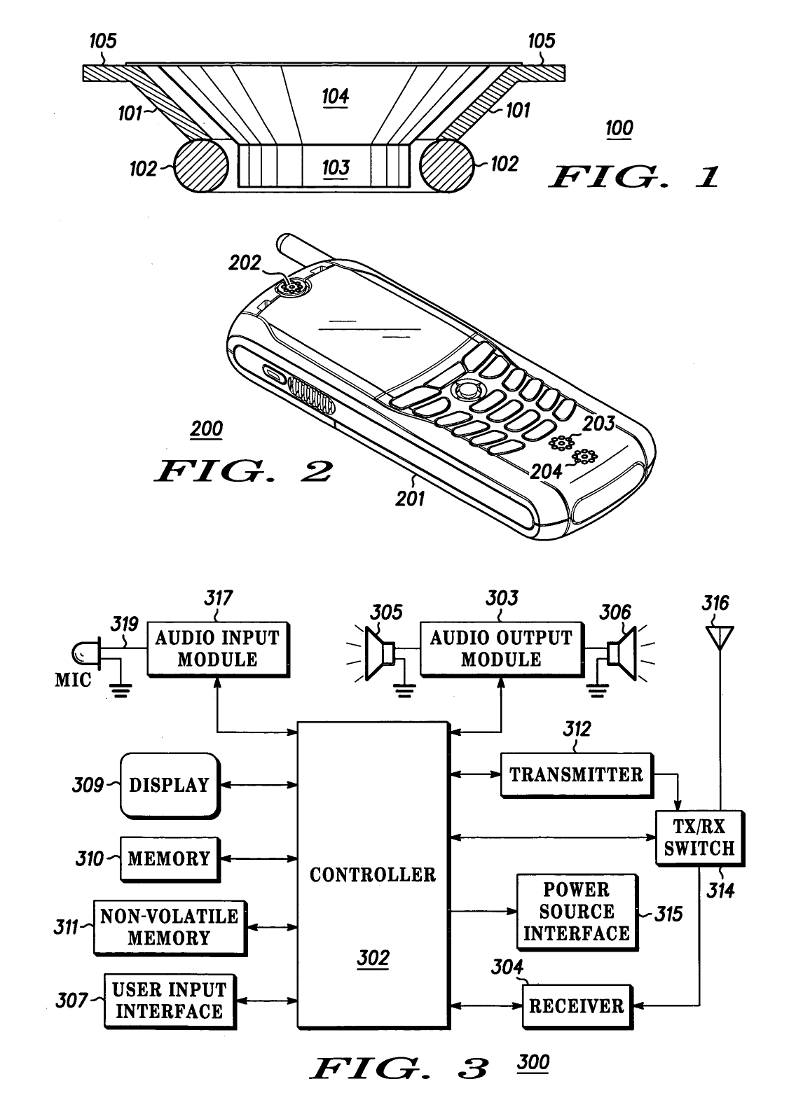

Referring to FIG. 2, there is shown a wireless phone 200, in accordance with a first embodiment of the invention. Housing 201 includes a first speaker (not shown) located behind a first speaker grill 202, and a microphone (not shown) located behind microphone grill 204. A second speaker (not shown) can be located behind a second speaker grill 203.

Exemplary Wireless Device Hardware Platform

Described now is an exemplary hardware platform for carrying out the present invention. Referring to FIG. 3, the electronic device 300 is any device 300 with an optional display including a wireless telephone, PDA, computer, electronic organizer, and other messaging device, and an electronic timepiece. The electronic device 300 includes a controller 302, a memory 310, a non-volatile (program) memory 311 for storing programs and filter values as more fully described below.

The device 300, in this example is a wireless communication device. The wireless communication device transmits and receives signals for enabling a wireless communication such as for a cellular telephone, in a manner well known to those of ordinary skill in the art. For example, when the wireless communication device 300 is in a “receive” mode, the controller 302 controls a radio frequency (RF) transmit/receive switch 314 that couples an RF signal from an antenna 316 through the RF transmit/receive (TX/RX) switch 314 to an RF receiver 304, in a manner well known to those of ordinary skill in the art. The RF receiver 304 receives, converts, and demodulates the RF signal, and then provides a baseband signal, for example, to audio output module 303 and a transducer 305, such as speakers 305 and 306, in the device 300 to provide received audio to a user. The speakers 305 and 306 in one embodiment are high audio (e.g., dispatch audio in two-way radios) and low audio (e.g., cellular earpiece audio) speakers. A microphone 319 is electrically coupled to an audio input module 317 for transmitting audio from the user. The receive operational sequence is under control of the controller 302, in a manner well known to those of ordinary skill in the art. In one embodiment, the controller 302 includes a DSP, a D/A and A/D converter.

In a “transmit” mode, the controller 302, for example responding to a detection of a user input (such as a user pressing a button or switch on a user interface 307 of the device 300), controls the audio circuits and a microphone interface (not shown), and the RF transmit/receive switch 314 to couple audio signals received from a microphone to transmitter circuits 312 and thereby the audio signals are modulated onto an RF signal and coupled to the antenna 316 through the RF TX/RX switch 314 to transmit a modulated RF signal into a wireless communication system (not shown). This transmit operation enables the user of the device 300 to transmit, for example, audio communication into the wireless communication system in a manner well known to those of ordinary skill in the art. The controller 302 operates the RF transmitter 312, RF receiver 304, the RF TX/RX switch 314, and the associated audio circuits (not shown), according to instructions stored in the program memory 311.

Further, the controller 302 is communicatively coupled to a user input interface 307 (such as a key board, buttons, switches, and the like) for receiving user input from a user of the device 300. It is important to note that the user input interface 307 in one embodiment is incorporated into the display 309 as “GUI (Graphical User Interface) Buttons” as known in the art. The user input interface 307 preferably comprises several keys (including function keys) for performing various functions in the device 300. In another embodiment the user interface 307 includes a voice response system for providing and/or receiving responses from the device user. In still another embodiment, the user input interface 307 includes one or more buttons used to generate a button press or a series of button presses such as received from a touch screen display or some other similar method of manual response initiated by the device user. The user input interface 307 couples data signals (to the controller 302) based on the keys depressed by the user. The controller 302 is responsive to the data signals thereby causing functions and features under control of the controller 302 to operate in the device 300. The controller 302 is also communicatively coupled to a display 309 (such as a liquid crystal display) for displaying information to the user of the device 300.

The present invention can be realized in hardware, software, or a combination of hardware and software. The present invention can also be embedded in a computer program product, which comprises all the features enabling the implementation of the methods described herein, and which—when loaded in the device 300—is able to carry out these methods.

Although wireless devices are described as one of the embodiments of the present invention, it is within the true scope and spirit of the present invention to include “wired” devices also. To those of average skill in the art, the transmission of audio packets over wired (i.e. telephone wire, coaxial, twisted pair wire, multi-conductor wire and more) in lieu of wireless is known.

Exemplary Two-Channel Input/One-Channel Output Embodiment

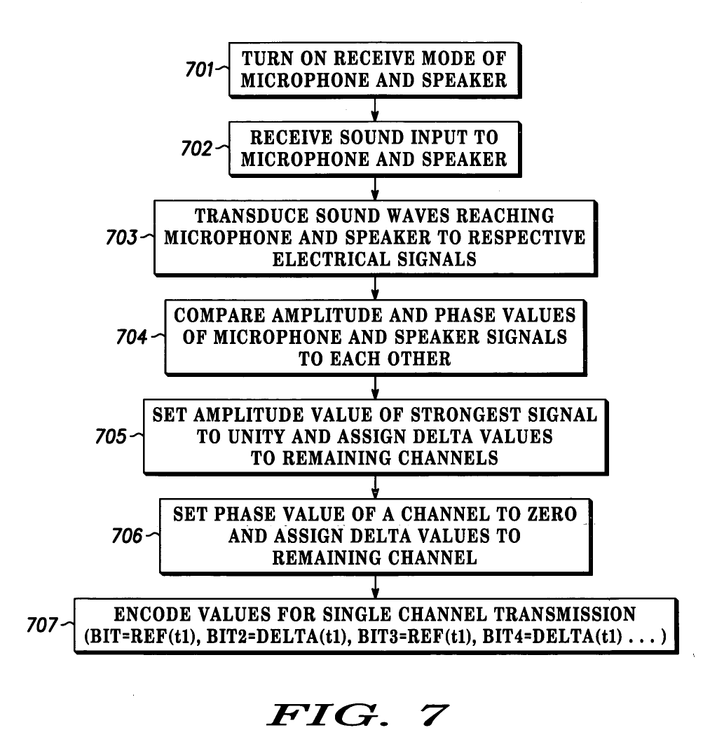

Described now is an exemplary hardware platform for carrying out the present invention using the flow diagram of FIG. 7. Referring now to FIG. 4, there is shown a diagram of a multi-channel audio capture system with at least one channel output. In the shown embodiment, a first channel is captured by microphone 401 and a second channel can be captured by speaker 402. Speaker 402 is placed into receive mode by closing switch 403. Once in receive mode, signals from the speaker 402 and the microphone 401 can be transferred to a comparator 404. Comparators are well known by those with ordinary skill in the art and is implemented in hardware, software or a combination of both. Comparator 404 identifies which of the audio channels has a predetermined signal strength so as to identify one of the audio channels as a reference audio channel. In one embodiment, the predetermined signal strength is the signal with the greatest amplitude, but does not necessarily have to be the strongest signal and it is within the true scope and spirit of the present invention to select other criteria for selecting the reference channel, such as power, phase difference and combinations thereof. Based on the comparison of the two channels, a value signal is sent to one of the two filters, 405 and 406. Filter 406 is connected directly to microphone 401 and filter 405 is connected to switch 403, which in turn, is connected to speaker 402. In one embodiment, the switch 403 along with other components of FIG. 4, are incorporated in the audio output module 303 of FIG. 3. The switch is any mechanical or electrical device such as a reed switch, diode or transistor. In one embodiment, each of the speakers are switched together logically i.e. multiple pole single-throw switch. In another embodiment, each speaker is switched independently. Filters 405 and 406 change through attenuation, amplification and/or phase shift, the signals received from speaker 402 and microphone 401, respectively, according to the output of the comparator 404. For instance, if the signal received from the speaker channel 402 has a larger amplitude than the signal received from the microphone channel 401, the comparator 404 outputs a value signal to filter 405, which, in turn, causes filter 405 to multiply the input signal by a corresponding value. In one embodiment, this value is the inverse of the input amplitude, resulting in a reference signal with a value of one. Similarly, comparator 404 also compares the phase difference between the two channels and outputs a corresponding value to the filters 405 and 406. In this manner, the phase value of one of the channels will be set to zero and the other will be the value of the phase difference compared to zero.

Exemplary Encoder

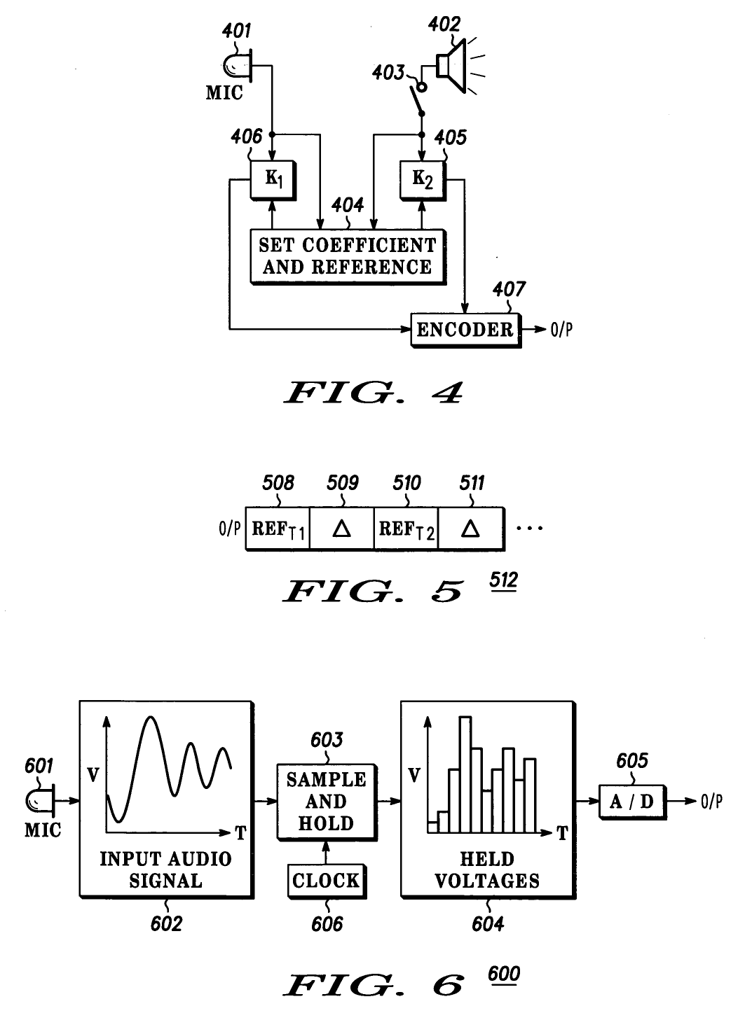

The outputs of the two filters, 405 and 406, are input to an encoder 407, which outputs a discrete-time, discrete-amplitude representation of the original analog audio signal. Encoders are well known by those of ordinary skill in the art. FIG. 6 shows the basic electronic components for encoding an audio signal for transmission. An input transducer, such as microphone 601, receives an airborne audio signal and converts it to an electrical analog signal 602. The next block 603, connected to clock 606, is a sample-and-hold analog circuit, which tracks the input voltage and samples it during a very short portion of the sampling period. An analog-to-digital converter 605 quantizes each of the succession of held voltages 604 and turns them into a sequence of binary numbers.

Exemplary Output Stream

Referring back to FIG. 4, the encoder 407 samples the amplitude of the continuous analog audio signal output from the filters 405 and 406 at each narrow pulse of a clock driven pulse train, yielding for each discrete time value a discrete voltage value. The encoder outputs a stream of data 512 consisting of sequential binary packets of information. Each packet is made of a specific number of bits. The final format of the encoder output is shown in FIG. 5. The first packet 508 contains reference signal data. The second packet 509 contains information regarding the amplitude and phase difference (delta) between the reference signal and the second channel. This pattern is repeated continuously, each time with a new packet of reference information 510 followed by a new packet of delta information 511.

Exemplary Flow Diagram

A flow diagram of a two-channel input/one-channel output system is shown in FIG. 7. The process begins at step 701, which is to place the speaker 402 into receive mode. This is done with a switch 403 that will complete a path from the speaker 402 to a receiving portion 405, 404 of the circuit. In step 702, a sound is received by the microphone 401 and speaker 402. In step 703 the sound waves are converted into electrical signals by transducers 401 and 402. Next, in step 704, the amplitude and phase components of the signals are compared to each other by comparator 404. In step 705 the amplitude value of the strongest signal is set to one and delta values are assigned to the remaining channel. In step 706, the phase value of one channel is set to zero and delta values are assigned to the remaining channel. Lastly, in step 707, the analog outputs of the two filters are encoded and transmitted on at least one channel, as shown in FIG. 5.

Exemplary Three-Channel Input/One-Channel Output

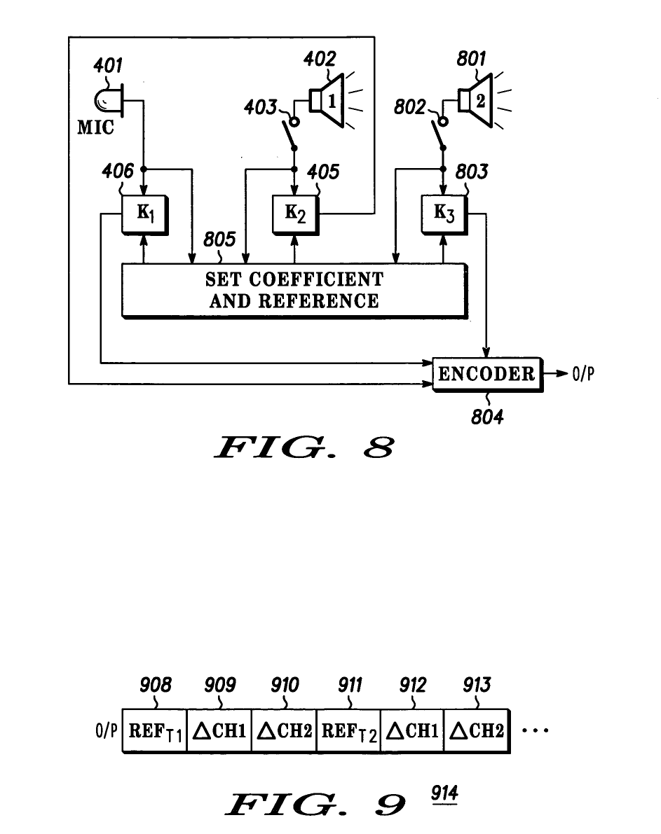

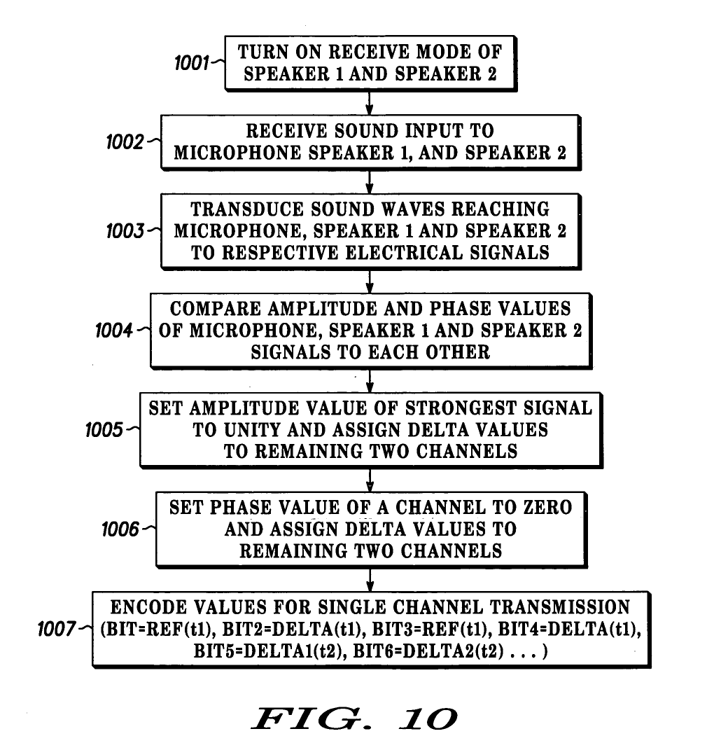

Described now is an exemplary hardware platform for carrying out the present invention using the flow diagram of FIG. 10. With reference to FIGS. 8 & 9, the multi-channel audio capture system of FIG. 4 is shown with one extra channel consisting of a second speaker 801 and a second switch 802 connecting the second speaker 801 to a third filter 803. The switch 802 is also connected to a three-input comparator 805. Additionally, the filter 803 is connected to a three-input encoder 804. In this configuration, the comparator 805 compares the amplitude and phase difference between the signal received from microphone 401, the signal received from speaker 402, and the signal received from speaker 801.

Comparator 805 identifies which of the audio channels has a predetermined signal strength so as to identify one of the audio channels as a reference audio channel. In one embodiment, the predetermined signal strength is the signal with the greatest amplitude, but does not necessarily have to be the strongest signal. Based on the comparison of the three channels, a value signal is sent to one of the three filters, 406, 405, and 803. Filters 406, 405, and 803 will act upon their respective input signals received from microphone 401, speaker 402, and speaker 801 according to the output of the comparator 805. For instance, if the signal received from the second channel (speaker 402) has a larger amplitude than the signal received from the first channel (microphone 401) and the third channel (speaker 801), the comparator 404 outputs a value signal to filter 405, which, in turn, causes filter 405 to multiply the input signal by a corresponding value. In one embodiment, this value is the inverse of the input amplitude, resulting in a value of one. In another embodiment, the reference audio channel amplitude is set to unity while the amplitude of the two remaining audio channels are set to 0.79 and 0.42 respectively. Similarly, comparator 404 also compares the phase difference between the three channels and outputs a corresponding value to the filters 405, 406, and 803. In this manner, the phase value of one of the channels will be set to zero and the others will be the value of the phase difference compared to zero.

Exemplary Output Stream Embodiment

The encoder outputs a stream of data 914 consisting of sequential binary packets of information. Each packet is made of a specific number of bits. The final format of the encoder output is shown in FIG. 9. The first packet 908 contains reference signal data. The second packet 909 contains information regarding the amplitude and phase difference (delta) between the reference signal and one of the channels other than the reference channel. The second packet 910 contains information regarding the amplitude and phase difference (delta) between the reference signal and another one of the channels other than the reference channel. This pattern is repeated continuously, each time with a new packet of reference information 911 followed by a new packet of delta information 912 followed by another packet of delta information 913.

Exemplary Flow Diagram

A flow diagram of a three-channel input/one-channel output system is shown in FIG. 10. The process begins at step 1001, which is to place speakers 402 and 801 into receive mode. This is done with switch 403 that completes a path from the speaker 402 to filter 405 and comparator 805, and with switch 802 that completes a path from speaker 801 to filter 803 and comparator 805. In step 1002, a sound is received by the microphone 401, speaker 402, and speaker 801. In step 1003 the sound waves are converted into electrical signals by transducers 401, 402, and 801. Next at step 1004, the amplitude and phase components of the signals are compared to each other. In step 1005, the amplitude value of the strongest signal is set to one and delta values are assigned to the remaining channel. Moving to step 1006, the phase value of one channel is set to zero and delta values are assigned to the remaining channel. Lastly, in step 1007, the analog outputs of the three filters are encoded and transmitted on at least one channel, as shown in FIG. 9.

It is important to note, that for each of multiple audio channel capture examples provided above, e.g. Two Input/One Channel Output and Three Input/One Channel Output, there is a corresponding multiple channel output. The multiple channel output received at a receiver (not shown) reconstructs each of the captured channels. Further, as described in the background of the invention, it is possible to construct more channels of output at a receiver than the number of streams being transmitted. For example, it is possible to use one channel to mathematically construct using filters, two or more channels. Likewise as discussed in the Background of the Invention, it is possible to create three or more channels from two output channels. Accordingly, the reconstruction can produce simulated stereo, stereo, quadraphonic, surround sound and a like to those of average skill in the art.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A wireless device for capturing multiple channel audio, the wireless device comprising:
at least one microphone for capturing a first audio channel;
a first speaker and a second speaker with at least one switch, wherein the switch is used to enable the first speaker to operate as a second microphone for capturing a second audio channel and the second speaker to operate as a third microphone for capturing a third audio channel, so that the microphone, the first speaker and the second speaker provide a plurality of audio channels;
a comparator, connected to the plurality of audio channels, so that the comparator identifies which of the plurality of audio channels has a predetermined signal strength so as to designate one of the plurality of audio channels as a reference audio channel; and
an encoder for receiving the plurality of audio channels to produce an output over at least one channel where the reference audio channel forms a reference signal and the plurality of audio channels, which do not include the reference signal, each form a delta signal from the reference channel.

2. The wireless device according to claim 1, further comprising at least one filter connected to the comparator for setting the amplitude of the reference channel to one.

3. The wireless device according to claim 2, wherein the at least one filter sets the amplitude of the audio channels other than the reference channel to a value other than one.

4. The wireless device according to claim 1, further comprising at least one filter connected to the comparator for setting the phase of the reference channel to zero.

5. The wireless device according to claim 4, wherein the at least one filter sets the phase value of the audio channels other than the reference channel to a value other than zero.

6. The wireless device according to claim 1, further comprising the predetermined signal strength of the first audio channel and the additional audio channels identified by the comparator is the signal with the greatest amplitude.

7. The wireless device according to claim 1, further comprising the encoder being a digital encoder.

8. The wireless device according to claim 7, further comprising the output of the encoder being in the format of a packet of reference signal information, followed by packets of delta signal information regarding each of the audio channels other than the reference signal, with the format repeated with new packets of information.

9. A wireless device for capturing multiple channel audio comprising:
at least one microphone for capturing a first audio channel;
one or more speakers with at least one switch, wherein the switch is used to enable at least one of the speakers to operate as an additional microphone when the device is in multiple channel audio capture mode for capturing additional audio channels;
a comparator, connected to the first audio channel and at least one of the additional audio channels so that the comparator identifies which of the first audio channel and the additional audio channels has a predetermined signal strength and then setting an audio channel with the predetermined signal strength as a reference audio channel; and
an encoder for receiving the first audio channel and the additional audio channels so as to produce an output over at least one channel where the audio reference channel forms a reference signal and the other audio channels form deltas therefrom.

10. The wireless device according to claim 9, further comprising at least one filter connected to the comparator for setting the amplitude of the reference channel to one.

11. The wireless device according to claim 10, wherein the at least one filter sets the amplitude of the audio channels other than the reference channel to a value other than one.

12. The wireless device according to claim 9, further comprising at least one filter connected to the comparator for setting the phase of the reference channel to zero.

13. The wireless device according to claim 12, wherein the at least one filter sets the phase value of the audio channels other than the reference channel to a value other than zero.

14. The wireless device according to claim 9, further comprising the predetermined signal strength of the first audio channel and the additional audio channels identified by the comparator is the signal with the greatest amplitude.

15. The wireless device according to claim 9, further comprising the encoder being a digital encoder.

16. The wireless device according to claim 15, further comprising the output of the encoder being in the format of a packet of reference signal information, followed by packets of delta signal information regarding each of the audio channels other than the reference signal, with the format repeated with new packets of information.

17. A device for capturing multiple channel audio, the device comprising:
a group of microphones for capturing an audio channel;
a group of speakers with at least one switch, wherein the switch is used to enable the group of speakers to operate as a second group of microphones for capturing at least one additional audio channel;
a comparator, connected to a plurality of audio channels including the audio channel captured by the microphone and the at least one additional audio channel captured by the group of speakers, so that the comparator identifies which of the audio channel captured by the microphone and the at least one additional audio channel captured by the group of speakers has a predetermined signal strength so as to designate one of the audio channel captured by the microphone and the at least one additional audio channel captured by the group of speakers as a reference audio channel; and
an encoder for receiving the plurality of audio channels to produce an output over at least one channel where the reference audio channel forms a reference signal and the audio channels other than the reference signal each form a delta signal from the reference channel.

18. The device according to claim 17, further comprising at least one filter connected to the comparator for setting the amplitude of the reference channel to one.

19. The device according to claim 18, wherein the at least one filter sets the amplitude of the audio channels other than the reference channel to a value other than one.

20. The device according to claim 17, further comprising at least one filter connected to the comparator for setting the phase of the reference channel to zero.

21. The device according to claim 20, wherein the at least one filter sets the phase value of the audio channels other than the reference channel to a value other than zero.

22. The device according to claim 17, further comprising the predetermined signal strength of the audio channel captured by the microphone and the at least one additional audio channel captured by the group of speakers identified by the comparator, is the signal with the greatest amplitude.

23. The device according to claim 17, further comprising the encoder being a digital encoder.

24. The device according to claim 23, further comprising the output of the encoder being in the format of a packet of reference signal information, followed by packets of delta signal information regarding each of the audio channels other than the reference signal, with the format repeated with new packets of information.

25. The device according to claim 17, wherein the group of speakers includes at least two speakers.

26. The device according to claim 17, wherein the output of the encoder is used in one of a wired and wireless transmission.

27. A method for capturing multiple channel audio on a wireless device, the method comprising:
capturing an audio channel from a group of microphones;
operating a group of speakers with at least one switch, wherein the switch is used to enable the group of speakers to operate as a second group of microphones for capturing at least one additional audio channel;
comparing a plurality of audio channels including the audio channel captured by the microphone and the at least one additional audio channel captured by the group of speakers, so as to identify which of the audio channel captured by the microphone and the at least one additional audio channel captured by the group of speakers has a predetermined signal strength so as to designate one of the audio channel captured by the microphone and the at least one additional audio channel captured by the group of speakers as a reference audio channel; and
encoding the plurality of audio channels to produce an output over at least one channel where the reference audio channel forms a reference signal and the audio channels other than the reference signal each form a delta signal from the reference channel.

28. The method according to claim 27, further comprising filtering one or more of the audio channels in order to set the amplitude of the reference audio channel to one.

29. The method according to claim 28, wherein the filtering one or more of the audio channels includes setting the amplitude of the audio channels other than the reference audio channel to a value other than one.

30. The method according to claim 27, further comprising filtering one or more of the audio channels in order to set the phase of the reference audio channel to zero.

31. The method according to claim 30, wherein the filtering one or more of the audio channels includes setting the phase of the audio channels other than the reference audio channel to a value other than zero.

32. The method according to claim 27, wherein the comparing the plurality of audio channels includes determining the signal with the greatest amplitude from the audio channel captured by the microphone and the at least one additional audio channel captured by the group of speakers.

33. The method according to claim 27, wherein the encoding the plurality of audio channels includes producing a format of a packet of reference signal information, followed by packets of delta signal information regarding each of the audio channels other than the reference signal, with the format repeated with new packets of information.

34. The method according to claim 27, wherein the operating the group of speakers includes operating at least two speakers.
